(19) United States
(12) Patent Application Publication
(10) Pub. No.: US 2009/0196157 A1
(43) Pub. Date: Aug. 6, 2009

(54) INFORMATION RECORDING MEDIUM

(75) Inventors: Naomasa NAKAMURA, Yokohama-shi (JP); Keiichiro YUSU, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/350,886

(22) Filed: Jan. 8, 2009

(30) Foreign Application Priority Data
Jan. 31, 2008 (JP) 2008-020949

(51) Int. Cl. G11B 7/24

(52) U.S. Cl. 369/275.1; G9B/7.139

(57) ABSTRACT

According to one embodiment, an information recording medium includes a substrate, a phase-change recording layer formed on the substrate, and a reflecting layer formed on the phase-change recording layer. The phase-change recording layer contains tellurium and antimony or bismuth as main components, has a crystallization rate of 2 to 10 ns, and forms a recording mark by changing its crystal state when irradiated with a light pulse having a half-width of 200 ps to 1 ns.

### CROSS-REFERENCE TO RELATED APPLICATIONS

This application is based upon and claims the benefit of priority from Japanese Patent Application No. 2008-020949, filed Jan. 31, 2008, the entire contents of which are incorporated herein by reference.

### BACKGROUND

1. Field

One embodiment of the present invention relates to an information recording medium for use in an optical recording/reproduction method of recording and reproducing information by using a laser beam.

2. Description of the Related Art

In a programmable information recording medium represented by a DVD RAM, DVD RW or the like, information is recorded, erased, and reproduced by irradiating a phase change recording layer made of a phase change recording material with a laser beam emitted from a light source having a specific wavelength.

Normally, the phase change recording layer is evenly crystallized in advance by heating, as initialization, the phase change recording layer material at a temperature greater than or equal to the crystallization temperature and equal to or lower than the melting point for a predetermined time. When recording information, this phase change recording layer is irradiated with a recording beam made up of light pulses. Consequently, a recording region irradiated with the recording beam amorphizes and forms a recording mark. The information can be recorded by using the phenomenon that the reflectance of the recording mark is lower than that of the crystallized unrecorded region. When reproducing recorded information, the information can be reproduced by using the reflectance difference between the recording mark and unrecorded region. When erasing information, as disclosed in, e.g., Jpn. Pat. Appln. KOKAI Publication No. 2002 208176, the recording mark can be erased by recrystallizing it by continuously irradiating it with a light beam. Performing recording and erase at the same time is normally called “overwrite”.

Two conditions are necessary to make amorphous recording possible. The first condition is that when irradiated with a laser beam, the irradiated portion melts. The second condition is that when the molten portion cools after irradiated with a laser beam, the cooling rate near the melting point of the material exceeds the critical cooling rate for amorphization of the material. A recording material used in a programmable optical disk such as a CD or DVD normally requires a cooling rate of about 10⁻⁹° C./sec.

In a DVD RAM, information is recorded along spiral trenches called grooves and lands like plateaus sandwiched between the grooves. Recently, the land groove interval which is 0.615 μm in a DVD RAM having a capacity of 4.7 GB on one side has decreased to 0.34 μm in an HD DVD RAM as a next generation DVD. Also, cross erase in which information recorded on a land (or in a groove) is partially erased when recording information on an adjacent groove (or in an adjacent land) is becoming a problem. This phenomenon cannot be avoided even in a DVD RW in which information is recorded only in grooves, and is no longer negligible even in an HD DVD RW having a groove interval of 0.4 μm.

The cross erase phenomenon is due to a beam size larger than the track width and the temperature distribution in the phase change recording layer resulting from the beam size. For example, the temperature becomes greater than or equal to the crystallization temperature if a beam edge that is recording information on a certain track passes through the end portion of an adjacent already recorded recording mark. Cross erase occurs if the temperature greater than or equal to the crystallization temperature is held for a time sufficient to cause crystallization at the end of the recording mark being cooled after that.

Also, the cross erase phenomenon strongly depends on the physical properties of a phase change material used.

A phase change material whose crystal growth rate, i.e., so called crystallization rate is very high when the material is cooled from a molten state is readily crystallized even under a high linear velocity condition in which the time during which a beam for erasing information passes through a recording mark is very short. This presumably makes high speed overwrite feasible. When recording information, however, a high crystallization rate makes amorphization of a recording mark difficult. The temperature of a recording region irradiated with a laser having a Gaussian intensity distribution is raised with a concentric temperature distribution, and at least a portion having exceeded the melting point amorphizes during cooling. In a material having a high crystallization rate, however, a portion having a low cooling rate recrystallizes. In a recording region irradiated with a laser beam, the cooling rate is high at the center of the irradiation portion where the temperature is high, and low at the periphery. Therefore, amorphization occurs in only the central portion, and the boundary of the recording mark recrystallizes. This is called a recrystallization ring. That is, to form a recording mark equivalent to the track width, it is necessary to melt a region larger than the track width by heating the region to a temperature greater than or equal to the melting point. If this molten region extends to an adjacent track, an already recorded recording mark on the adjacent track may be partially recrystallized, thereby destroying and erasing information.

As described above, it is difficult to suppress the formation of a recrystallization ring and decrease the track pitch without causing any cross erase by using a eutectic phase change recording layer that can be readily crystallized even at a high linear velocity.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a sectional view showing an information recording medium according to a first embodiment of the invention;

FIG. 2 is a timing chart showing an example of a drive current containing recording pulses and a high frequency signal, and an example of an NRZI waveform;

FIG. 3 is a block diagram of an information recording/reproduction apparatus to which the present invention is applicable;

FIG. 4 is a timing chart showing other examples of the drive current containing recording pulses and a high frequency signal, and the NRZI waveform;

FIG. 5 is a timing chart showing still another example of the drive current containing recording pulses and a high frequency signal, still another example of the NRZI waveform, an example of channel data, and an example of an optical waveform;

FIG. 6 is a timing chart showing still another example of the drive current containing recording pulses and a high frequency signal, still another example of the NRZI waveform, and another example of the channel data;

FIG. 7 is a timing chart showing still other examples of the drive current containing recording pulses and a high frequency signal, the NRZI waveform, and the channel data;

FIG. 8 is a timing chart showing still other examples of the drive current containing recording pulses and a high frequency signal, the NRZI waveform, and the channel data;

FIG. 9 is a sectional view showing another example of the information recording medium of the present invention;

FIG. 10 is a sectional view showing still another example of the information recording medium of the present invention; and

FIG. 11 is a timing chart showing an example of a pulse waveform used in the present invention.

### DETAILED DESCRIPTION

Various embodiments according to the invention will be described hereinafter with reference to the accompanying drawings. In general, according to one embodiment of the invention, an information recording medium that comprises a substrate, a phase-change recording layer formed on the substrate, and a reflecting layer formed on the phase-change recording layer is obtained. The phase-change recording layer contains tellurium and antimony or bismuth as main components, has a crystallization rate of 2 to 10 ns, and forms a recording mark by changing its crystal state when irradiated with a light pulse having a half-width of 200 ps to 1 ns.

The main component herein mentioned is an element or element group having a highest component ratio among components forming a material such as a phase-change recording layer.

The present invention uses the information recording medium having the phase-change recording layer that contains a combination of tellurium and antimony or a combination of tellurium and bismuth as the main component, has a crystallization rate of 2 to 10 ns, and records information when irradiated with a light pulse having a half-width of 200 ps to 1 ns, thereby preventing easy formation of a recrystallization ring in a mark peripheral portion after the portion is melted. Therefore, a recording mark on an adjacent track is hardly erased, and the recording mark interval can be decreased. This makes high-density recording possible.

The phase-change recording material used in the present invention and capable of high-speed crystallization can crystallize when held in a temperature region greater than or equal to the crystallization temperature and equal to or lower than the melting point for about a few tens of nanoseconds. Accordingly, crystallization in a cooling process after melting is rapid. Since information can be easily erased by high-speed overwrite, therefore, high-speed data transfer is possible.

As described above, the use of the present invention makes it possible to form an amorphous recording mark by using a sub-ns light pulse even when using as a recording material having a high crystallization rate at which no information can be recorded because the material recrystallizes if a normal nanosecond-order light pulse is used. The phase-change recording material according to the present invention has a high crystallization rate and cannot be amorphized with a nanosecond-order light pulse. However, amorphous recording is made possible by combining the material with sub-ns light pulse recording.

Also, the present invention uses the phase-change recording layer containing tellurium and antimony or bismuth as main components and having a crystallization rate of 2 to 10 ns, and performs recording by emitting a light pulse having a half-width of 200 ps to 1 ns. Since no recrystallization ring is easily formed, therefore, the extension of a recording mark to an adjacent track can be prevented. This makes it possible to perform overwrite without causing any cross-erase on a recording mark of an adjacent track. When temperature simulation is performed under conditions that form an amorphous mark almost equal to the track width, the temperature of an adjacent track hardly exceeds the melting point during beam irradiation regardless of the linear velocity. This indicates that ideal recording by which no recrystallization ring is formed in a mark peripheral portion is possible.

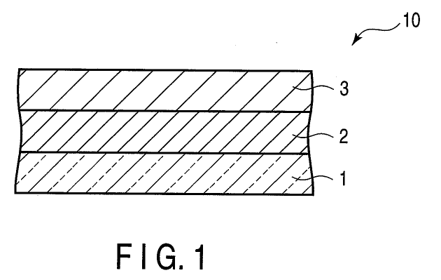

FIG. 1 is a sectional view showing an example of the structure of the information recording medium according to the present invention.

As shown in FIG. 1, a medium 10 comprises a substrate 1 made of polycarbonate or the like, a phase-change recording layer 2 formed on the substrate 1, and a reflecting layer 3 formed on the phase-change recording layer 2 and made of, e.g., Ag or Al.

The phase-change recording layer is made of an SbTe-based compound or BiTe-based compound as a intermetallic compound having a high crystal growth rate.

According to an aspect of the present invention, when the phase-change recording layer is made of SbTe, the content of Sb can be 38 to 42 at %, and that of Te can be 58 to 62 at %. The content of Sb can also be about 40 at %, and that of Te can also be about 60 at %.

According to another aspect of the present invention, when the phase-change recording layer is made of BiTe, the content of Bi can be 38 to 42 at %, and that of Te can be 58 to 62 at %. The content of Bi can also be about 40 at %, and that of Te can also be about 60 at %.

The optical contrast and recording characteristics of an SbTe-based intermetallic compound or SbBi-based intermetallic compound can be further improved by adding a proper amount of a side component such as Ge to the compound.

The side component herein mentioned is an element or element group having a component ratio lower than that of the main component among components forming a material such as a phase-change recording layer, and has an influence on the characteristics of the material.

According to still another aspect of the present invention, an example of a BiTe—GeTe-based pseudo binary compound is a compound represented by

(Bi₂Te₃)ₓ(GeTe)₁₋ₓ (i)

wherein x is 0.1 to 1.

x can also be 0.31 to 0.35, or 0.65 to 0.69.

Furthermore, x can be about 0.33 or about 0.67.

According to still another aspect of the present invention, an example of an SbTe—GeTe-based pseudo binary compound is a compound represented by

(Bi₂Te₃)_{y}(GeTe)_{1-y} (ii)

wherein y is 0.1 to 1.

y can also be 0.31 to 0.35, or 0.65 to 0.69.

Furthermore, y can be about 0.33 or about 0.67.

An optical interference layer used to increase the change in reflectance before and after recording or to mechanically or thermally protect the recording layer is preferably a composite compound made of ZnS:SiO₂, SiO₂, Al₂O₃, Si₃N₄, ZrO₂, AlN, Cr₂O₃, GeN, Ta₂O₅, or Nb₂O₅. The optical interference layer has not only a function of performing optical enhancement but also a function of reducing the stress applied to the recording layer, and a function of controlling the temperature rise caused by laser emission.

To achieve these functions, the optical interference layer may also be made of two or more layers.

As the reflecting layer, it is possible to form a layer containing, e.g., Al, Ag, and Au as main components. The reflection layer is formed to obtain reflected light during reproduction, and also has a function of controlling the temperature when a beam is emitted during recording.

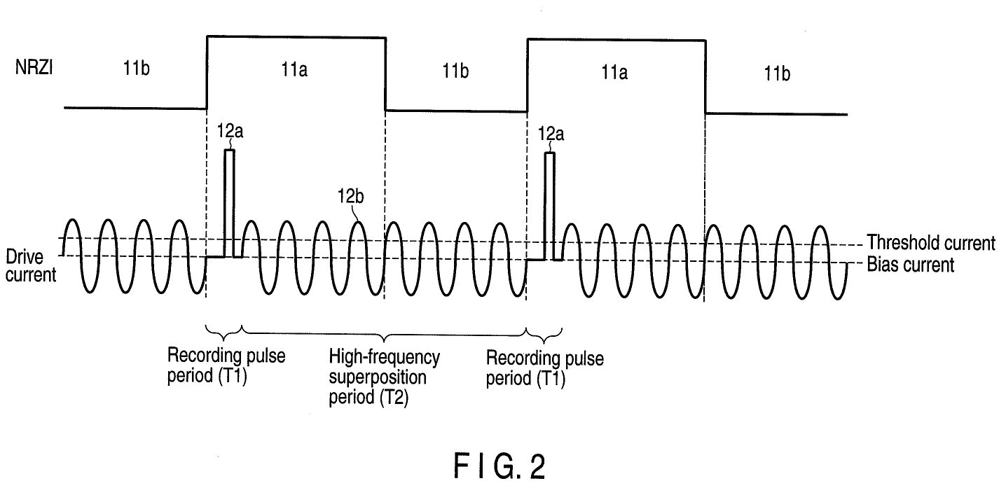

FIG. 2 shows representative waveform examples in recording.

That is, FIG. 2 shows data (NRZI) to be recorded, and the drive current waveform, which corresponds to the data, of a laser diode (LD). The drive current waveform contains a recording pulse period (T1) and high-frequency signal superposition period (T2).

A recording pulse 12a is output once or a plurality of number of times in a mark portion 11a. In periods except for the recording pulse periods (T1), a high-frequency signal is output regardless of the mark portion 11a and a space portion 11b. This maintains the average light intensity of the laser diode.

In the recording pulse period (T1), the drive current causes the laser diode to emit light with light emission intensity higher than that in the high-frequency signal superposition period (T2). This intense light emission thermally changes the recording layer of the optical disk, thereby forming a recording mark. In the high-frequency signal superposition period (T2), the drive current has a magnitude by which the average light intensity of the laser diode causes neither a thermal change nor an optical change in the recording layer of the optical disk. This light intensity is in many cases equivalent to the intensity when reading information from the recording layer of the optical disk. The level of a threshold current shown in FIG. 2 is a boundary level at which the laser diode starts or stops light emission. To obtain relaxation oscillation, the laser diode requires a recording pulse that steeply changes from a level equal to or lower than this threshold current level. To record information, therefore, the recording pulse 12a that steeply changes must be obtained by making the current less than or equal to the threshold current once from the current for obtaining the light intensity when reading information from the recording layer of the optical disk. In the recording mode, the light intensity when reading information from the optical disk is necessary when reading an address or the like.

A period during which the drive current is constant as a bias current can sometimes be formed between the recording pulse 12a and a high-frequency signal 12b.

As described above, in recording using a sub-nano pulse, light having a high light emission intensity is obtained by producing a state called relaxation oscillation in the laser diode. Accordingly, light emission continues as the light emission intensity attenuates even after the drive current is stopped after the recording pulse 12a. A bias period during which the drive current is constant is formed after the recording pulse 12a until relaxation oscillation converges.

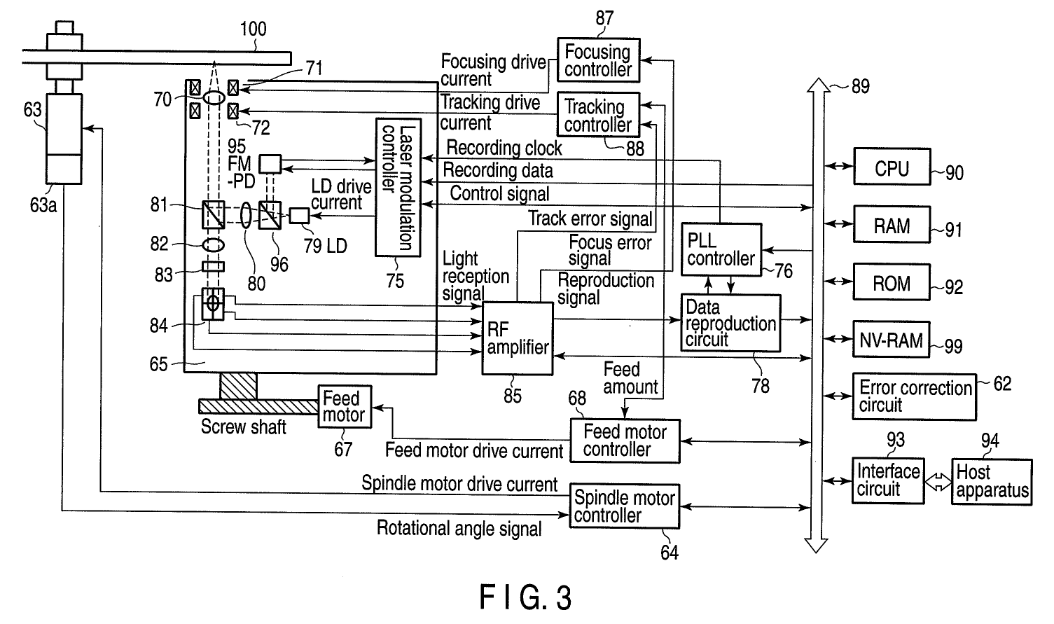

FIG. 3 is an overall block diagram of an information recording/reproduction apparatus to which the information recording medium of the present invention is applicable. This information recording/reproduction apparatus records and reproduces information with respect to an optical disk 100 having the features of the information recording medium (optical disk) described above. The optical disk 100 has concentric or spiral trenches. A recessed portion of the trench is called a land, a projecting portion of the trench is called a groove, and each turn of the groove or land is called a track. User data is recorded by emitting an intensity-modulated laser beam along the track (the groove alone or both the groove and land), thereby forming a recording mark. Data is reproduced by emitting, along the track, a laser beam having read power lower than recording power, and detecting the change in reflected light intensity caused by a recording mark on the track. Recorded data is erased by emitting, along the track, a laser beam having erase power higher than the read power, and crystallizing the recording layer.

A spindle motor 63 rotates the optical disk 100. A rotary encoder 63A attached to the spindle motor 63 outputs a rotational angle signal. Five pulses, for example, are output as this rotational signal when the spindle motor 63 rotates once. On the basis of the rotational angle signal, a spindle motor controller 64 determines the rotational angle and rotational speed of the spindle motor 63.

An optical head 65 records and reproduces information with respect to the optical disk 100. The optical head 65 is coupled with a feed motor 67 via a gear and screw shaft. A feed motor controller 68 controls the feed motor 67. When a feed motor drive current from the feed motor controller 68 rotates the feed motor 67, the optical head 65 moves in the radial direction of the optical disk 100.

The optical head 65 has an objective lens 70 supported by a wire or leaf spring (not shown). The objective lens 70 can move in a focusing direction (the optical axis direction of the lens) when driven by a drive coil 72. Also, the objective lens 70 can move in a tracking direction (a direction perpendicular to the optical axis of the lens) when driven by a drive coil 71.

When recording information (forming a mark), a laser modulation controller 75 provides a write signal to a laser diode (laser-emitting element) 79 on the basis of recording data supplied from a host apparatus 94 via an interface circuit 93.

A laser beam emitted by the laser diode 79 enters a half mirror 96. The half mirror 96 branches, at a predetermined ratio, the laser beam emitted by the laser diode 79.

A monitoring photodetector (FM-PD) 95 comprising a photodiode receives a partial beam of the laser beam from the half mirror 96. The monitoring photodetector (FM-PD) 95 detects the partial beam proportional to the emission power of the laser beam, and supplies a light reception signal to the laser modulation controller 75. On the basis of the light reception signal from the monitoring photodetector 95, the laser modulation controller 75 controls the output beam from the laser diode 79 so as to appropriately obtain reproducing laser power, recording laser power, and erasing laser power set by a central processing unit (CPU) 90.

The laser diode 79 emits a laser beam in accordance with a drive current supplied from the laser modulation controller 75. The laser beam emitted from the laser diode 79 impinges on the optical disk 100 via a collimator lens 80, a half prism 81, and the objective lens 70. The reflected beam from the optical disk 100 is guided to a read photodetector 84 via the objective lens 70, the half prism 81, a condenser lens 82, and a cylindrical lens 83.

The read photodetector 84 comprises, e.g., four equally divided photodetection cells, and these photodetection cells output detection signals to an RF amplifier 85. The RF amplifier 85 processes the signals from the photodetection cells, and generates a focusing error signal FE indicating an error from an in-focus position, a tracking error signal TE indicating an error between the beam spot center of the laser beam and the track center, and a reproduction signal as a total addition signal of the photodetection cell signals.

The focusing error signal FE is supplied to a focusing controller 87. The focusing controller 87 generates a focusing drive signal in accordance with the focusing error signal FE. The focusing drive signal is supplied to the drive coil 71 for focusing. Thus, focusing servo is performed such that the laser beam is always just focused on the recording film of the optical disk 100.

The tracking error signal TE is supplied to a tracking controller 88. The tracking controller 88 generates a tracking drive signal in accordance with the tracking error signal TE. The tracking drive signal output from the tracking controller 88 is supplied to the drive coil 72 for tracking. In this way, tracking servo is performed so that the laser beam always traces tracks formed on the optical disk 100.

Since the focusing servo and tracking servo described above are performed, changes in reflected beams from recoding marks formed on the tracks of the optical disk 100 in accordance with recording information are reflected on the total addition signal RF of the output signals from the photodetection cells of the read photodetector 84. This signal is supplied to a data reproduction circuit 78. The data reproduction circuit 78 reproduces recorded data on the basis of a reproduction clock signal from a PLL circuit 76.

While the tracking controller 88 is controlling the objective lens 70, the feed motor controller 68 controls the feed motor 67, i.e., the optical head 65 so as to position the objective lens 70 near a predetermined position in the optical head 65.

The CPU 90 controls, via a signal bus 89, the spindle motor controller 64, the feed motor controller 68, the laser modulation controller 75, the PLL circuit 76, the data reproduction circuit 78, the focusing controller 87, the tracking controller 88, an error correction circuit 62, and the like. The CPU 90 collectively controls this recording/reproduction apparatus in accordance with operation commands provided by the host apparatus 94 via the interface circuit 93. Also, the CPU 90 uses a RAM 91 as a work area, and performs a predetermined operation in accordance with a control program recorded in a ROM 92 by properly referring to parameters of each individual apparatus recorded in a nonvolatile memory (NV-RAM) 99. The error correction circuit 62 corrects an error of a reproduction signal.

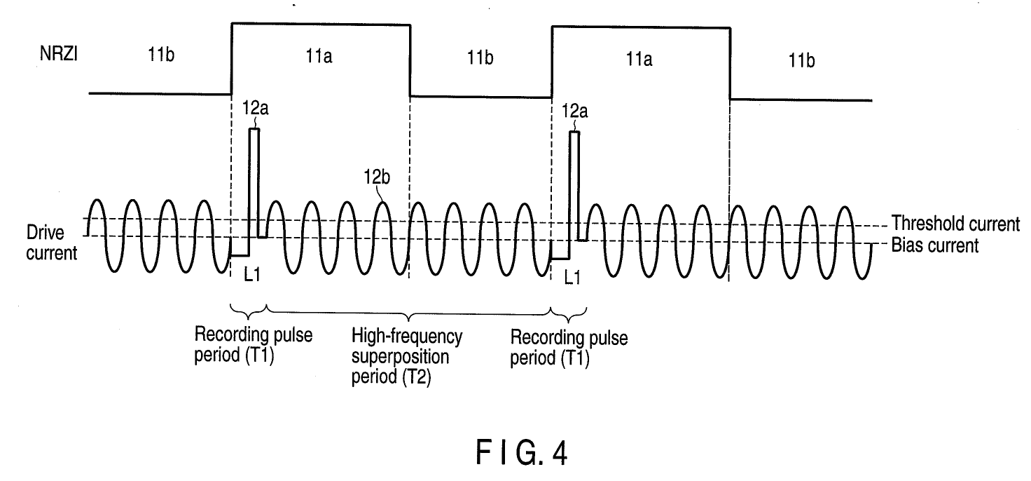

To generate a large relaxation oscillation in the laser diode (LD) 79, a method of supplying, to the laser diode 79, a current waveform by which a low current (L1) is generated before the peak pulse as shown in FIG. 4 is also favorable.

To generate the relaxation oscillation, a current supplied to the LD must fall to Ith (supply current at the start of laser emission) or less immediately before LD emission. A period for which the supply current falls to Ith or less is a minimum of 0.5 ns or more, and preferably 3.0 ns or more to generate relaxation oscillation emission. As a result of experimental evaluation, a very stable relaxation oscillation occurs when the period is 10 ns or more.

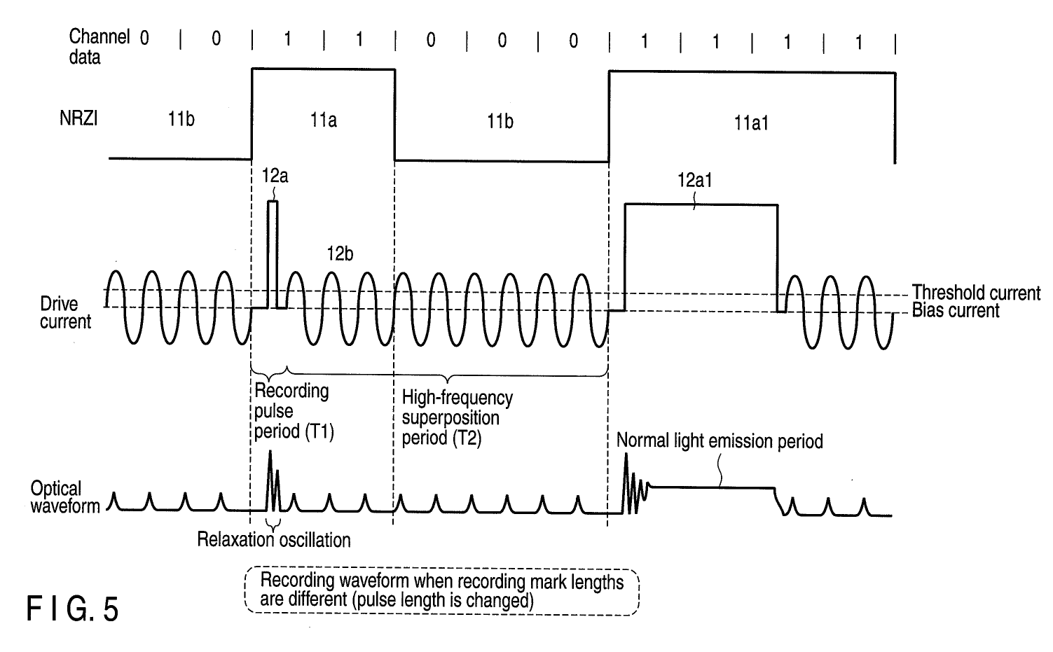

As has been described above, only one relationship between the current for driving the laser diode and the NRZI waveform is illustrated as shown in FIG. 1, for the descriptive convenience. However, various types of NRZI waveforms are used depending on channel data. Recording pulses for effectively forming mark and space portions on the recording medium are generated in accordance with the NRZI waveform. The examples of various recording pulse patterns are shown in FIGS. 5 to 8, and the characteristics of the relaxation oscillation generated by the laser diode are also described with reference to FIGS. 5 to 8.

FIG. 5 shows channel data and an NRZI waveform generated on the basis of the data. FIG. 5 also shows examples of a laser diode drive current and an output optical waveform from the laser diode when recording data is recorded.

In the example shown in FIG. 5, when recording recording mark portions having different lengths, recording is performed by controlling the length (pulse width) of a recording pulse in proportion to the length of the mark portion. That is, FIG. 5 shows examples of channel data as data to be recorded, and the NRZI waveform, drive current waveform, and assumed optical waveform corresponding to the channel data.

Assuming that the length of channel bits in which N “1”s continue is NT, the length of recording pulses 12a and 12a1 is generally (N−2)+0.1 T or (N−3)+0.1 T or less. T indicates the length of one channel bit of a reference clock.

The length of one period of relaxation oscillation is generally 100 ps to 1 ns. Therefore, when recording pulses are applied for 0.05 T (about 750 ps) at a channel clock frequency of 64.8 MHz (1 T is about 15 ns), relaxation oscillation made up of about one or two waves is obtained. In a short recording mark (2 T or 3 T), information can be recorded by this relaxation oscillation alone.

On the other hand, in a long recording mark, relaxation oscillation converges, and the laser takes a continuous oscillation state. In this case, information is recorded by a combination of recording by relaxation oscillation and recording by normal laser emission; recording is first performed by relaxation oscillation immediately after a current pulse is applied, and then performed by normal light emission after the relaxation oscillation converges.

The level of a threshold current shown in FIG. 5 is a boundary level at which the laser diode starts or stops light emission. To obtain relaxation oscillation, the laser diode requires a recording pulse that steeply changes from a level equal to or lower than this threshold current level. A period during which this level equal to or lower than the threshold current level can be 1 to 5 ns. Accordingly, when performing a recording process while a drive current greater than or equal to the threshold position is output in order to read or erase an address, a means for making the level equal to or lower than the threshold value once and then generating a steep recording pulse is necessary.

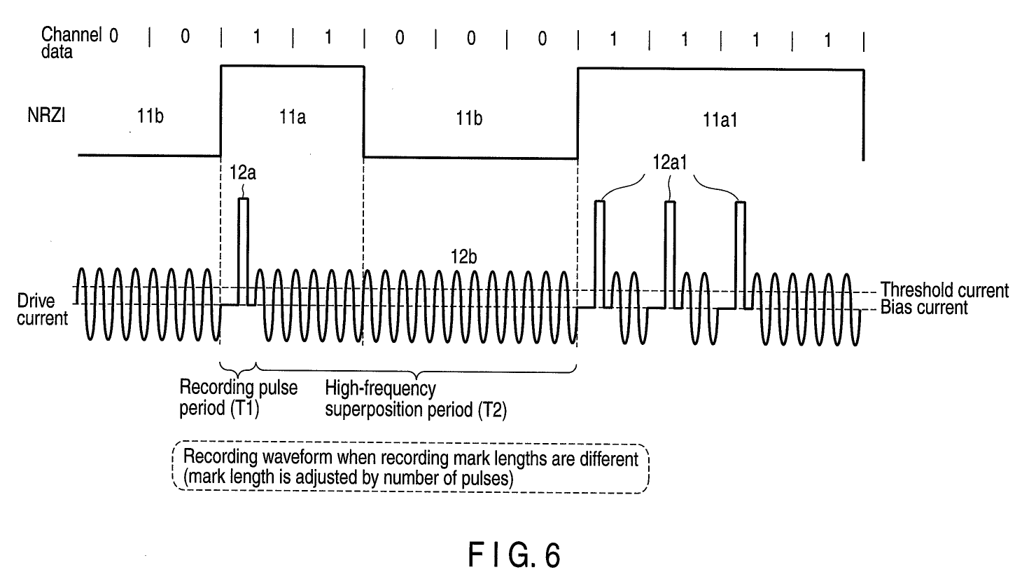

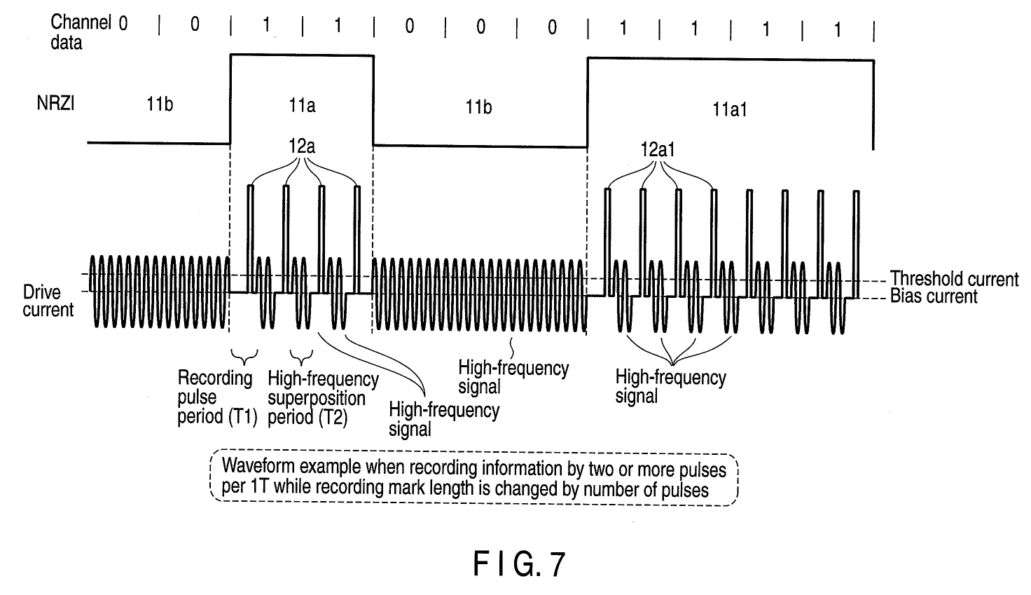

FIG. 6 shows an example in which information is recorded by increasing the number of recording pulses in proportion to the mark length. Assuming that the length of channel bits in which N “1”s continue is NT, the number of recording pulses is M×(N−J)+K where M is a natural number, and J and K are integers. Therefore, a waveform in which M=2 and J=K=0 as shown in FIG. 7 can also be used. The average light amount during recording is increased by inserting a high-frequency superposition wave between the recording pulses. Consequently, high peak pulses are repeated by relaxation oscillation, so information can be recorded by an average drive current smaller than that of the example shown in FIG. 5.

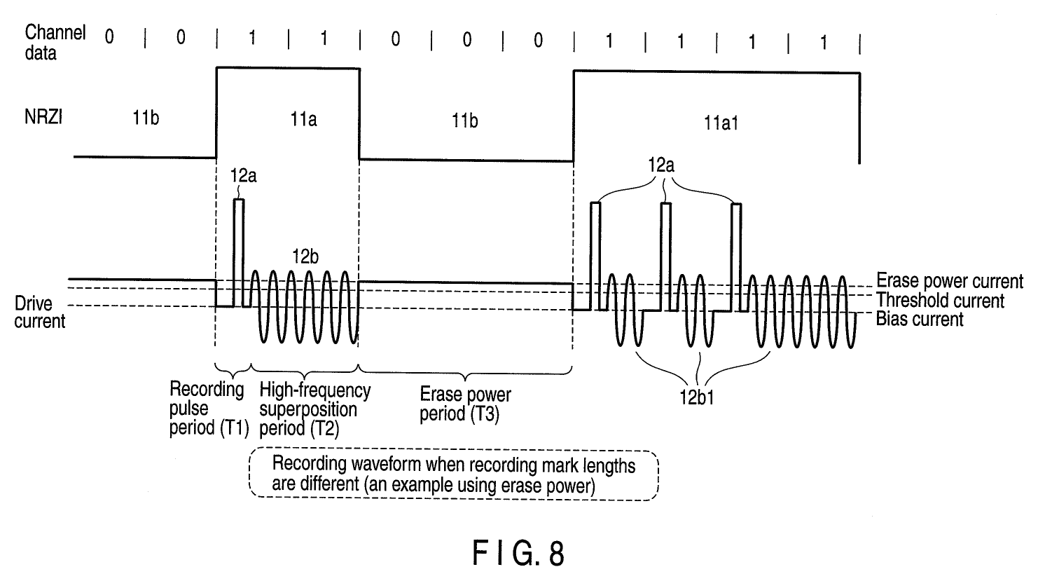

FIG. 8 shows the case where erase power is applied instead of high-frequency superposition in the space portion shown in FIG. 6, and shows a recording waveform suited to a programmable medium. This modification in which erase power is applied to the space portion is similarly applicable to the examples shown in FIGS. 5 to 7 as well as FIG. 8.

### EXAMPLES

The present invention will be explained in more detail below by way of its examples.

A polycarbonate disc substrate 0.6 mm in thickness and 120 mm in diameter having spiral grooves 25 nm in depth formed at a track pitch of 0.4 μm on the surface was used. On this substrate, a 50-nm-thick ZnS:SiO₂ film as a first protective layer, a 15-nm-thick phase-change recording material described in Table 1 below, a 20-nm-thick ZnS:SiO₂ film as a second protective layer, and a 100-nm-thick Al alloy reflecting layer were sequentially stacked by sputtering, thereby obtaining an optical recording medium. The film thickness was controlled by the sputtering time of each sputtering source.

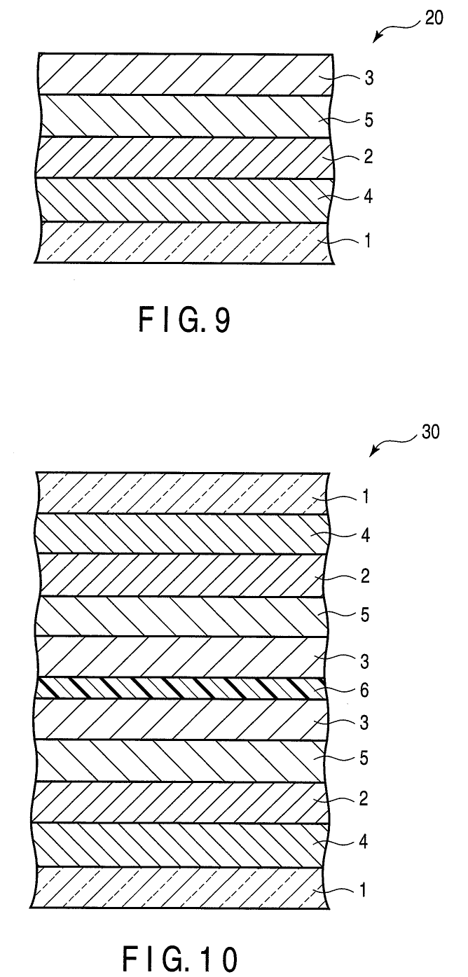

FIG. 9 shows the arrangement of the obtained optical recording medium.

As shown in FIG. 9, an optical recording medium 20 has an arrangement in which a first protective layer 4, phase-change recording layer 2, second protective layer 5, and reflecting layer 3 are sequentially stacked on a substrate 1.

Then, a substrate having the same shape as that of the substrate on which the films were thus formed was prepared, and a sample was prepared by adhering the two substrates by using an ultraviolet-curing resin.

FIG. 10 shows the obtained sample.

As shown in FIG. 10, a sample 30 is a double-sided, two-layered medium obtained by adhering the reflecting layers 3 of the optical recording media 20 via an adhesion layer 6.

The phase-change recording layers of the sample thus manufactured were crystallized in advance because they were normally amorphous. This crystallization was done by irradiating DC light at a power of 1,000 mW while the sample disk was rotated at 600 rpm, by using a long elliptic beam having a wavelength of 810 nm and a beam size of 1 μm×96 μm. In this manner, the sample disk having the crystallized phase-change recording layers was manufactured.

The compositions of the phase-change recording layers of the sample disk were changed by using Bi₂Te₃ and GeTe as sputtering sources of the phase-change recording materials, and controlling the input power to each sputtering source. A short-pulse recording experiment was conducted on this disk sample. Information was recorded by using a pulse string having a half-width of 0.6 ns as recording pulses.

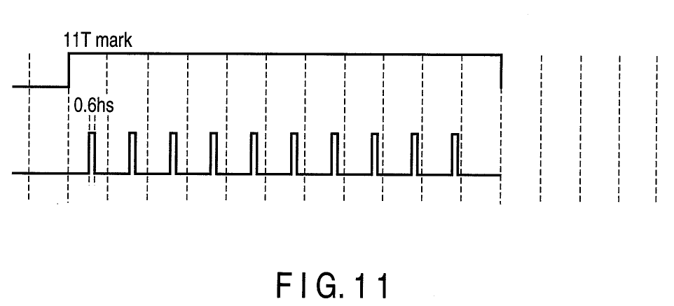

The recording conditions were that the liner velocity was 6.61 m/s, the recording power was 40 mW, and a short pulse string having a pulse width of 0.6 ns was used. Modulation was ETM (8/12) modulation, and the actual mark length was 2 T to 11 T for (1, 10RLL). FIG. 11 shows the pulse waveform. In short-pulse recording, a short pulse having a half-width of 0.6 ns was irradiated at the start position of each T, and the number of pulses is T−1.

After the recording, recording marks of each sample disk were observed by using a transmission microscope. As a consequence, no recrystallization ring was found in any sample disk.

The signal quality was evaluated by using the SbER (Simulated bit Error Rate) and PRSNR (Partial Response Signal Noise Ratio). The SbER and PRSNR indices the signal quality of an HD DVD. The SbER is an error rate, so the lower the value, the higher the quality. The PRSNR is a signal-to-noise ratio, so the higher the value, the higher the quality. The standard value of the SbER is 5.0×10⁻⁵ or less, and that of the PRSNR is 15 or more.

TABLE 1

| | Phase change recording | | |
|---|---|---|---|
| Sample | layer composition | SbER | PRSNR |
| 1 | Bi₂Te₃ | 2.3 × 10⁻⁸ | 32.2 |
| 2 | (Bi₂Te₃)_{0.1}(GeTe)_{0.9} | 4.5 × 10⁻⁶ | 15.6 |
| 3 | (Bi₂Te₃)_{0.2}(GeTe)_{0.8} | 1.2 × 10⁻⁶ | 17 |
| 4 | (Bi₂Te₃)_{0.33}(GeTe)_{0.67} | 5.4 × 10⁻⁷ | 25 |
| 5 | (Bi₂Te₃)_{0.4}(GeTe)_{0.6} | 5.2 × 10⁻⁷ | 24.2 |
| 6 | (Bi₂Te₃)_{0.5}(GeTe)_{0.5} | 6.3 × 10⁻⁷ | 23.8 |
| 7 | (Bi₂Te₃)_{0.67}(GeTe)_{0.33} | 6.5 × 10⁻⁸ | 30.5 |
| 8 | (Bi₂Te₃)_{0.8}(GeTe)_{0.2} | 9.2 × 10⁻⁷ | 24 |
| 9 | (Bi₂Te₃)_{0.9}(GeTe)_{0.1} | 1.6 × 10⁻⁶ | 23.4 |
| 10 | Sb₂Te₃ | 5.4 × 10⁻⁸ | 31.5 |
| 11 | (Sb₂Te₃)_{0.1}(GeTe)_{0.9} | 3.2 × 10⁻⁶ | 22.8 |
| 12 | (Sb₂Te₃)_{0.2}(GeTe)_{0.8} | 6.3 × 10⁻⁷ | 25.6 |
| 13 | (Sb₂Te₃)_{0.33}(GeTe)_{0.67} | 8.7 × 10⁻⁹ | 35.2 |
| 14 | (Sb₂Te₃)_{0.4}(GeTe)_{0.6} | 6.9 × 10⁻⁷ | 28.4 |
| 15 | (Sb₂Te₃)_{0.5}(GeTe)_{0.5} | 1.0 × 10⁻⁶ | 23.0 |
| 16 | (Sb₂Te₃)_{0.67}(GeTe)_{0.33} | 5.0 × 10⁻⁸ | 33.8 |
| 17 | (Sb₂Te₃)_{0.8}(GeTe)_{0.2} | 6.9 × 10⁻⁷ | 26.5 |
| 18 | (Sb₂Te₃)_{0.9}(GeTe)_{0.1} | 4.4 × 10⁻⁶ | 20.0 |

As shown in Table 1 above, in each sample disk in which the recording layer was formed by using a phase-change recording material represented by Bi₂Te₃, Sb₂Te₃, (Bi₂Te₃)ₓ(GeTe)₁₋ₓ . . . (i) (wherein 0.1≦x≦1), or (Sb₂Te₃)_{y}(GeTe)_{1-y} . . . (ii) (wherein 0.1≦y≦1), both the SbER and PRSNR satisfied the standard values of an HD DVD, i.e., good signal characteristics were obtained.

Note that when the content of Bi₂Te₃ was 31 to at % and that of GeTe was 65 to 69 at %, and when the content of Bi₂Te₃ was 65 to 69 at % and that of GeTe was to 35 at %, the phase-change recording layer crystallized by sputtering alone. Therefore, it was unnecessary to perform any crystallization process beforehand. Furthermore, favorable values were obtained for both the SbER and PRSNR within these composition ranges.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information recording medium comprising a substrate, a phase-change recording layer formed on the substrate comprising tellurium and either antimony or bismuth with a crystallization rate of 2 to 10 nanoseconds, and configured to form a recording mark by changing a crystal state of the phase-change recording layer when irradiated with a light pulse having a half-width of 200 picoseconds to 1 nanosecond, and a reflecting layer formed on the phase-change recording layer.

2. The medium of claim 1, wherein the phase-change recording layer comprises 38 to 42 atomic percent (at %) of bismuth and 58 to 62 at % of tellurium.

3. The medium of claim 2, wherein the phase-change recording layer further comprises germanium as a side component.

4. The medium of claim 3, wherein the phase-change recording layer is represented by a following composition formula,
(Bi₂Te₃)ₓ(GeTe)₁₋ₓ (i)
wherein 0.1≦x≦1.

5. The medium of claim 1, wherein the phase-change recording layer comprises 38 to 42 at % of antimony and 58 to 62 at % of tellurium.

6. The medium of claim 5, wherein the phase-change recording layer further comprises germanium as a side component.

7. The medium of claim 6, wherein the phase-change recording layer is represented by a following composition formula,
(Bi₂Te₃)_{y}(GeTe)_{1-y} (ii)
wherein 0.1≦y≦1.
